(19) United States
(12) Patent Application Publication
(10) Pub. No.: US 2014/0165094 A1
(43) Pub. Date: Jun. 12, 2014

(54) ROAMING TARGETED ADVERTISING FOR A VIDEO SERVICES SYSTEM

(71) Applicant: ECHOSTAR TECHNOLOGIES L.L.C., Englewood, CO (US)

(72) Inventor: Christofer Hardy, Cheyenne, WY (US)

(73) Assignee: ECHOSTAR TECHNOLOGIES L.L.C., Englewood, CO (US)

(21) Appl. No.: 13/711,257

(22) Filed: Dec. 11, 2012

(51) Int. Cl. H04N 21/81

(52) U.S. Cl. CPC H04N 21/812
USPC 725/34

(57) ABSTRACT

A targeted advertising method for a video services system is presented herein. The method begins by determining that a mobile device is within local proximity to a video services receiver, using a wireless communication capability of the mobile device. In response to the determining, the method identifies a current user of the mobile device and accesses a subscriber profile for the current user. The subscriber profile includes user-specific targeted advertising data for the current user. The method continues by performing targeted advertising directed to the current user, wherein the performing is influenced by the user-specific targeted advertising data.

### TECHNICAL FIELD

Embodiments of the subject matter described herein relate generally to content delivery systems such as video services systems. More particularly, embodiments of the subject matter relate to targeted advertising techniques suitable for use with a video services system.

### BACKGROUND

Most television viewers now receive their video signals through a content aggregator such as a cable or satellite television provider. In a typical scenario, encoded audio/video signals are sent via a cable or wireless data link to the viewer's home, where the signals are ultimately decoded in a video services receiver (e.g., a set-top box (STB) or other consumer device). The decoded signals can then be viewed on a television or other appropriate display as desired by the viewer. Most video service providers include commercials, advertisements, and/or marketing content interspersed between segments of program content, as is well understood.

Targeted advertising attempts to deliver advertising content to viewers in an intelligent manner that is dictated by certain characteristics of the viewers. For example, targeted advertisements directed to sports cars can be selectively run during sporting event programming or directed to certain households or neighborhoods having a high population of viewers that are likely to be in the market for automobiles. As another example, web-based targeted advertising can be very individualized and customized such that specific advertisements are directed to a user's web browser in response to that user's browsing history. In the context of a video services system that utilizes video receivers installed at subscriber premises, advertising can be customized on a receiver-by-receiver basis in a fairly straightforward manner.

It is desirable to provide targeted advertising via a video services system in a way that is user-specific, such that individualized targeted advertising can “roam” with the users. Furthermore, other desirable features and characteristics will become apparent from the subsequent detailed description and the appended claims, taken in conjunction with the accompanying drawings and the foregoing technical field and background.

### BRIEF SUMMARY

A targeted advertising method for a video services system is presented herein. The method may begin by determining that a mobile device is within local proximity to a video services receiver, wherein the determining uses a wireless communication capability of the mobile device. In response to the determining, the method identifies a current user of the mobile device, and then accesses a subscriber profile for the current user. The subscriber profile includes user-specific targeted advertising data for the current user. The method may continue by performing targeted advertising directed to the current user, wherein the performing is influenced by the user-specific targeted advertising data.

An embodiment of a video services system is also presented herein. The video services system includes a network interface, a memory element, and a processor. The network interface communicates data between the video services system and a plurality of video services receivers. The memory element is used to store a plurality of subscriber profiles, each of the plurality of subscriber profiles including user-specific targeted advertising data for a different subscriber supported by the video services system. The processor is coupled to the network interface and to the memory element. The processor determines that a mobile device is within local proximity to one of the plurality of video services receivers, identifies a current user of the mobile device, accesses a designated subscriber profile for the current user from the plurality of subscriber profiles, and performs targeted advertising directed to the current user of the mobile device in accordance with the user-specific targeted advertising data in the designated subscriber profile.

An embodiment of a targeted advertising method for a video services system is also presented herein. The method may begin by establishing a short-range wireless link between a mobile device and a video services receiver. The method continues by receiving, from the mobile device and via the short-range wireless link, a user identifier that identifies a current user of the mobile device. The user identifier is communicated from the video services receiver to a network-based server of the video services system. The method may continue by performing a targeted advertising action at the video services receiver, wherein the targeted advertising action is influenced by user-specific targeted advertising data maintained by the network-based server in association with the user identifier.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a video services system;

FIG. 2 is a schematic representation of an embodiment of a video services receiver suitable for use in the system shown in FIG. 1;

FIG. 3 is a schematic representation of an embodiment of a network-based server suitable for use in the video services system shown in FIG. 1;

FIG. 4 is a flow chart that illustrates an embodiment of a setup process that may be performed by a video services system;

FIG. 5 is a flow chart that illustrates an embodiment of a roaming targeted advertising process that may be performed by a video services system;

FIG. 6 is a flow chart that illustrates an embodiment of an active targeted advertising scheme; and

FIG. 7 is a flow chart that illustrates an embodiment of a stealth targeted advertising scheme.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. Moreover, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The exemplary embodiments described herein relate to a video delivery system such as a satellite or cable television system. The disclosed subject matter relates to a targeted advertising methodology that provides advertising content to subscribers of the video services system. More specifically, the disclosed subject matter relates to the management, processing, and handling of individualized targeted advertising that can roam with mobile devices operated by the subscribers. In some embodiments, the video receivers discover mobile devices that are located within a compact wireless range of the receivers. Subscriber profiles, which are linked to the mobile devices, are maintained by one or more backend servers of the video delivery system. The subscriber profiles include targeted advertising guidance data and content preferences for the corresponding mobile device users. Thus, user-specific targeted advertising can be provided to a user of a mobile device whenever a compatible video services receiver detects the local presence of the mobile device. In other words, user-specific targeted advertising content can roam with mobile devices of the subscribers.

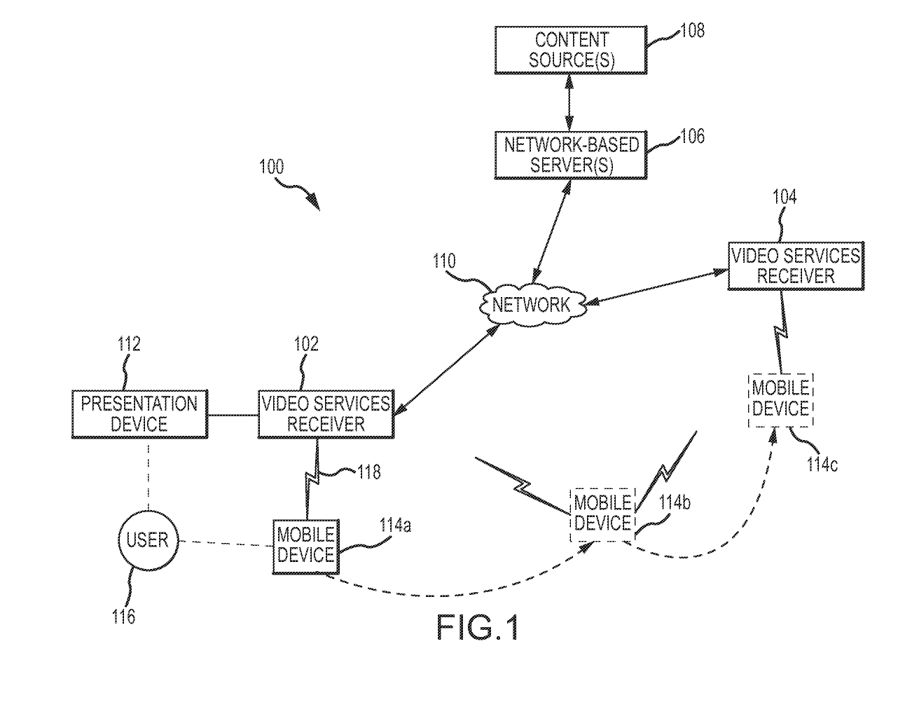

Turning now to the drawings, FIG. 1 is a schematic representation of an embodiment of a video services system 100 that is suitably configured to support the targeted advertising techniques and methodologies described in more detail herein. The video services system 100 may utilize satellite-based data delivery, cable-based data delivery, cellular-based data delivery, or a combination thereof. The specific details of such delivery systems and related data communication protocols will not be described here.

The system 100 (which has been simplified for purposes of illustration) generally includes, without limitation: a number of physically distinct video services receivers 102, 104; at least one network-based server 106; and at least one content source 108. Although FIG. 1 depicts only two video services receivers 102, 104, it should be appreciated that the system 100 may support any number of video services receivers, and that a typical video services system may include video services receivers that are geographically distributed throughout a large area, such as a city, a county, a region, or the like. The video services receivers 102, 104 communicate with the network-based server 106 and/or the content source 108 via a data communication network 110. It should be appreciated that the content source 108 may be realized as a physically distinct and remote device relative to the network-based server 106, or it may be integrally implemented with the network-based server 106. Moreover, a physically distinct content source 108 may communicate with the network-based server 106 via the data communication network 110 if so desired. The content source 108 provides media content (such as video programming, advertising content, music programming, and other audio, video, or audiovisual content) to the network-based server 106, which in turn provides the media content to the video services receivers 102, 104 as needed. For the sake of brevity, conventional techniques related to video/media communication systems, video/media broadcasting systems, data transmission, signaling, network control, and other functional aspects of the systems (and the individual operating components of the systems) may not be described in detail herein.

Each video services receiver 102, 104 may include or cooperate with a suitably configured presentation device 112, such as a display device, a monitor, or the like. For simplicity, the presentation device for the video services receiver 104 is not depicted in FIG. 1. The presentation device 112 may be, without limitation: a television set; a monitor; a computer display; a portable electronic device; or any suitable customer appliance with compatible display capabilities. In various embodiments, each video services receiver 102, 104 is a conventional set-top box commonly used with satellite or cable television distribution systems. In other embodiments, however, the functionality of a video services receiver 102, 104 may be commonly housed within a presentation device. In still other embodiments, a video services receiver is a portable device that may be transportable with or without the presentation device 112. A video services receiver 102, 104 may also be suitably configured to support broadcast television reception, video game playing, personal video recording and/or other features as desired.

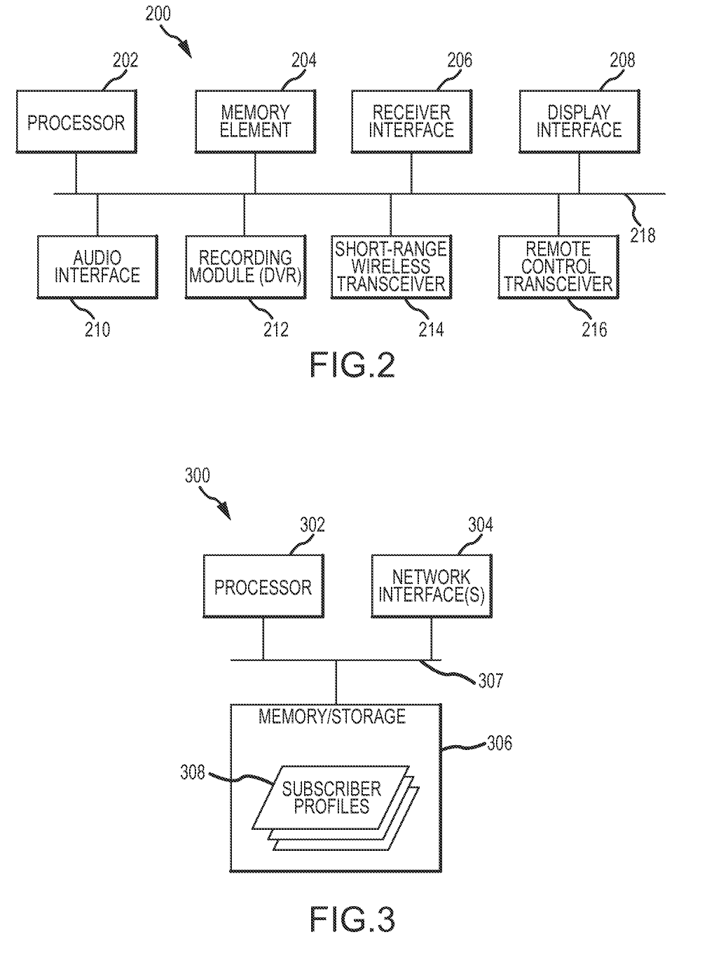

During typical operation, the video services receivers 102, 104 receive programming (such as primary program content interspersed with segments of secondary content, commercials, and/or targeted advertising), signaling information, and/or other data via the data communication network 110. The video services receivers 102, 104 then demodulate, decompress, descramble, and/or otherwise process the received digital data, and then convert the received data to suitably formatted video signals that can be rendered for viewing by the customer on the presentation devices. Additional features and functions of the video services receiver 102 are described below with reference to FIG. 2.

The system 100 is suitable configured for compatibility with mobile devices of the type that are typically carried and used by the subscribers of the system 100. In this regard, the system 100 may be compatible with any or all of the following types of mobile devices, without limitation: cellular telephone devices; portable computing devices (including tablet computers, laptop computers, netbook computers, and handheld computers); portable digital media players; portable video game devices; portable medical devices; global positioning system (GPS) devices; watches; portable electronic toys; eyewear having electronic or wireless capabilities; or the like.

FIG. 1 depicts a mobile device 114 that is carried and operated by a user 116. The mobile device 114a is shown in a location that is within local proximity to the video services receiver 102. Thus, the user 116 is assumed to be within the same local range of the video services receiver 102 and the presentation device 112 such that content presented by the video services receiver 102 can be viewed and/or heard by the user 116. In some embodiments, the mobile device 114 is within local proximity to a given video services receiver when a short-range wireless data communication link 118 can be established between the mobile device 114 and the given video services receiver. The short-range wireless data communication link 118 may be created and maintained using a suitable short-range wireless communication protocol that is natively supported by the mobile device. Accordingly, the “local proximity” relative to a video services receiver may be defined as the wireless range of the native short-range wireless technology supported by the mobile device 114. The mobile device 114 may support any appropriate short-range wireless communication technology, including, without limitation: Wi-Fi wireless communication technology; BLUETOOTH wireless communication technology; wireless USB technology; infrared technology; or the like.

FIG. 1 also depicts the mobile device 114 in two different locations that represent possible “roaming” locations of the mobile device 114 (i.e., potential future locations of the mobile device 114). The position of the mobile device 114b corresponds to a location where the mobile device 114b is too far away from any video services receiver and, consequently, it cannot establish a short-range wireless data communication link with a video services receiver. In contrast, the position of the mobile device 114c corresponds to a location where the mobile device 114c is within wireless range of the video services receiver 104. The dashed arrows in FIG. 1 represent a roaming path of the mobile device 114: (1) the mobile device 114 is initially located near (within wireless range of) the video services receiver 102; (2) the mobile device 114 is moved to a location where it loses all short-range wireless connectivity with the video services receivers 102, 104; and (3) the mobile device 114 is moved to a location that is within wireless range of the video services receiver 104.

FIG. 2 is a schematic representation of an embodiment of a video services receiver 200 suitable for use in the video services system 100 shown in FIG. 1. The video services receiver 200 is designed and configured to provide media content to a user, by way of one or more presentation devices. The media content may include targeted advertising content that is selected and provided to the video services receiver 200 in accordance with the techniques and methodologies described in more detail herein. It should be appreciated that “media content” is used here in a general sense, and that “media content” is intended to include audio-only content, video-only content, audiovisual content, a series or sequence of still images, or any combination thereof. Accordingly, although primary audiovisual content will typically represent a program event that includes a video component and a corresponding audio soundtrack, such content need not always include both audio and video components. For example, a music or radio channel of a video services system may include little to no video content. Nonetheless, the audio content provided by such a channel is still regarded as media content for purposes of this description.

This illustrated embodiment of the video services receiver 200 generally includes, without limitation: at least one processor 202; at least one memory element 204 having a suitable amount of memory associated therewith; a receiver interface 206; a display interface 208 for a display; an audio interface 210; a recording module 212; a short-range wireless transceiver 214; and a remote control transceiver 216. These components and elements may be coupled together as needed for purposes of interaction and communication using, for example, an appropriate interconnect arrangement or architecture 218. It should be appreciated that the video services receiver 200 represents a “full featured” embodiment that supports various features described herein. In practice, an implementation of the video services receiver 200 need not support all of the enhanced features described here and, therefore, one or more of the elements depicted in FIG. 2 may be omitted from a practical embodiment. Moreover, a practical implementation of the video services receiver 200 will include additional elements and features that support conventional functions and operations.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 202 may be realized as a microprocessor, a controller, a microcontroller, or a state machine. Moreover, the processor 202 may be implemented as a combination of computing devices, e.g., a combination of a digital signal processor and a microprocessor, a plurality of microprocessors, one or more microprocessors in conjunction with a digital signal processor core, or any other such configuration.

The memory element 204 may be realized using any number of devices, components, or modules, as appropriate to the embodiment. Moreover, the video services receiver 200 could include a memory element 204 integrated therein and/or a memory element 204 operatively coupled thereto, as appropriate to the particular embodiment. In practice, the memory element 204 could be realized as RAM memory, flash memory, EPROM memory, EEPROM memory, registers, a hard disk, a removable disk, or any other form of storage medium known in the art. In certain embodiments, the memory element 204 includes a hard disk, which may also be used to support integrated DVR functions of the video services receiver 200. The memory element 204 can be coupled to the processor 202 such that the processor 202 can read information from, and write information to, the memory element 204. In the alternative, the memory element 204 may be integral to the processor 202. As an example, the processor 202 and the memory element 204 may reside in a suitably designed ASIC.

The memory element 204 can be used to store and maintain information for use by the video services receiver 200. For example, the memory element 204 may be used to obtain and store subscriber profiles for a plurality of different users of the video services receiver 200 and/or for a plurality of registered mobile devices that are owned or operated by subscribers of the video services system 100 (as described in more detail below with reference to FIG. 3). The memory element 204 may also be utilized to store recorded content such as broadcast program events and a library of downloaded advertisements or commercials that could be selected for purposes of targeted advertising directed to the current user of the video services receiver 200. Of course, the memory element 204 may also be used to store additional data as needed to support the operation of the video services receiver 200.

The receiver interface 206 is suitably configured to receive and perform front end processing on signals received by the video services receiver 200. In this regard, the receiver interface 206 can receive data associated with any number of services (e.g., video services), including video streams that include or represent primary audiovisual content, advertising content, and the like. The data received and processed by the receiver interface 206 may also include metadata related to the audiovisual content, on-screen menus, GUIs, interactive programming interfaces, etc. The receiver interface 206 may leverage conventional design concepts that need not be described in detail here.

The display interface 208 is operatively coupled to one or more display elements (not shown) at the customer site. The display interface 208 represents the hardware, software, firmware, and processing logic that is utilized to render graphics, images, video, and other visual indicia on the customer's display. In this regard, the display interface 208 facilitates the presentation of video streams, programs, and advertising segments on the display(s) at the customer premises. For example, the display interface 208 is capable of providing primary program content, targeted advertising content, general advertising content, graphical interactive programming interfaces for video services, interactive listings of recorded programs, interactive graphical menus, interactive user questionnaires, and other GUIs for display to the user. The display interface 208 may leverage conventional design concepts that need not be described in detail here.

The audio interface 210 is coupled to one or more audio system components (not shown) at the customer site. The audio interface 210 represents the hardware, software, firmware, and processing logic that is utilized to generate and provide audio signals associated with the operation of the video services receiver 200. Depending upon the particular embodiment, the audio interface 210 may be tangibly or wirelessly connected to the audio portion of a television or monitor device, or it may be tangibly or wirelessly connected to a sound system component that cooperates with the television or monitor device.

The recording module 212 is operatively coupled to the receiver interface 206 to record program events provided by the incoming services. In practice, the recording module 212 may include, cooperate with, or be realized as hardware, software, and/or firmware that is designed to provide traditional DVR features and functions for the video services receiver 200. Accordingly, the recording module 212 may record video programs provided by video services, audio-only programs provided by audio services, or the like. As mentioned above, the recording module 212 cooperates with the memory element 204 to store the recorded content 222 as needed.

The short-range wireless transceiver 214 performs short-range wireless communication with one or more compatible mobile devices, which may be carried by users and subscribers when in close proximity to the video services receiver 200. The short-range wireless transceiver 214 enables the video services receiver 200 to wirelessly detect and discover the presence of a compatible mobile device within a local range of the video services receiver 200, in accordance with well-known techniques and technologies. In this regard, the short-range wireless transceiver 214 may be suitably configured to generate and transmit beacons, pings, discovery messages, and/or other wireless signals that are intended to elicit some type of response from mobile devices that are within wireless range of the video services receiver 200. The short-range wireless transceiver 214 may also be configured to receive beacons, pings, discovery messages, and/or other wireless signals that are communicated from mobile devices that are attempting to establish wireless connectivity with the video services receiver 200. In some embodiments, the short-range wireless transceiver 214 is compatible with Wi-Fi wireless technology, BLUETOOTH wireless technology, and/or infrared wireless technology.

The remote control transceiver 216 performs wireless communication with one or more compatible remote devices, such as a remote control device, a portable computer, an appropriately equipped mobile telephone, or the like. The remote control transceiver 216 enables the user to remotely control various functions of the video services receiver 200, in accordance with well-known techniques and technologies. In certain embodiments, the remote control transceiver 216 cooperates with a remote control device to configure subscriber profiles, to enter user responses to questions related to targeted advertising preferences, or other feedback associated with the operation of the video services receiver 200.

FIG. 3 is a schematic representation of an embodiment of a video services server 300 suitable for use in the video services system 100 shown in FIG. 1. The server 300 may be realized as a network-based server associated with a headend facility, a satellite uplink facility, or a content management facility maintained by the system provider. The server 300 may include, without limitation: at least one processor 302; at least one network interface 304; and at least one memory or storage element 306. These components and elements may be coupled together as needed for purposes of interaction and communication using, for example, an appropriate interconnect arrangement or architecture 307. It should be appreciated that a practical implementation of the server 300 will include additional elements and features that support conventional functions and operations.

The processor 302 and the memory element 306 may be generally configured as described above for their counterpart elements in the video services receiver 200. For the sake of brevity, the general characteristics of the processor 302 and the memory element 306 will not be redundantly described in the context of the server 300. It should be appreciated that the processor 302 can be suitably configured to support the various server and backend operations and functions described in more detail herein. The memory element 306 is suitably configured to maintain, store, and update subscriber profiles 308 for one or more users of the video services system. The subscriber profiles 308 will be described in more detail below.

The network interface 304 is suitably configured to receive and perform processing on signals received by the server 300 and to transmit signals from the server 300. The network interface 304 is used to communicate data between the server 300 and a plurality of video services receivers supported by the server 300. In practice, the network interface 304 may communicate with media content sources, video services receivers, and/or other network-based servers using a network such as the data communication network 110 depicted in FIG. 1. In some embodiments, the network interface 304 may also support communication with one or more cellular networks. As described in more detail below, data received by the network interface 304 may include, without limitation: media content; subscriber profile information; user identifiers; mobile device identifiers; user commands associated with the operation of video services receivers; usage statistics and data related to the use of video services receivers in the system; user-entered responses to interactive questionnaires or polls; or the like. Data provided by the network interface 304 may include, without limitation: media content; targeted advertising content; interactive questionnaires related to targeted advertising schemes; graphical user interfaces associated with the operation of video services receivers; or the like. The network interface 304 may leverage conventional design concepts that need not be described in detail here.

As mentioned briefly above, the video services system 100 presented here utilizes subscriber profiles 308 in connection with the provision of targeted advertising. Some embodiments maintain and update the subscriber profiles 308 at the server 300 (as shown in FIG. 3). Alternatively (or additionally), some or all of the subscriber profiles 308 could be stored at the video services receivers and/or at the mobile devices if so desired. The implementation described here assumes that the subscriber profiles 308 are stored at the server 300 for the sake of security and persistence.

The system 100 can store any number of subscriber profiles 308 per user. For the embodiments described here, however, the system 100 maintains one subscriber profile 308 per registered user of the system. Each subscriber profile 308 includes, is linked to, or is otherwise associated with user-specific data or information for the particular user (e.g., targeted advertising data for the respective user). In this regard, each subscriber profile 308 may include or be associated with an identifier (e.g., a subscriber ID, a user ID, a username, or user credentials) that is unique within the domain of the system 100. A subscriber profile 308 may also include, define, or indicate certain user-specified preferences, options, or settings that influence the operation of the video services receivers in the system 100. This allows the system 100 to maintain corresponding user-specific targeted advertising data for each registered user. Moreover, each subscriber profile 308 may also include or be associated with at least one mobile device identifier (e.g., a device ID or serial number) that is linked to the user. Accordingly, the subscriber profile 308 for a given user may include a list of registered mobile devices that are owned or operated by that particular user such that targeted advertising can be provided to that user regardless of which mobile device he or she is using at any moment. Furthermore, one mobile device could be identified in a plurality of different subscriber profiles 308 if that mobile device supports multiple user profiles. For example, a single laptop computer device may support four different users via four different login credentials. Consequently, there could be up to four different subscriber profiles 308 that identify that particular laptop computer as a registered mobile device, where each of the different subscriber profiles 308 link the device ID of the laptop computer to a different subscriber ID.

As explained in more detail below, the user-specific targeted advertising data associated with a given subscriber profile 308 can be used to determine, select, or influence targeted advertising content to be delivered to the user as that user roams between compatible video services receivers. In practice, the targeted advertising methodology is performed in a manner that is influenced by the user-specific targeted advertising data. In addition, the system 100 can modify and dynamically update the user-specific targeted advertising data as needed to enhance the relevance of advertisements presented to each subscriber. The amount and type of user-specific targeted advertising data associated with a subscriber profile 308 may vary from one profile to another, from one system to another, from one region to another, and the like. In some embodiments, the user-specific targeted advertising data may include any or all of the following types of data, without limitation: age of the current user; gender of the current user; nationality of the current user; ethnicity of the current user; occupation of the current user; education level of the current user; usage statistics associated with use of the video services receiver by the current user; media content preferences of the current user; advertising preferences of the current user; demographic data associated with the current user; address data associated with the current user; telephone number data associated with the current user; personality traits of the current user; familial information associated with the current user; and subject matter preferences of the current user. Of course, other types and forms of data could be utilized in connection with a subscriber profile 308 if so desired.

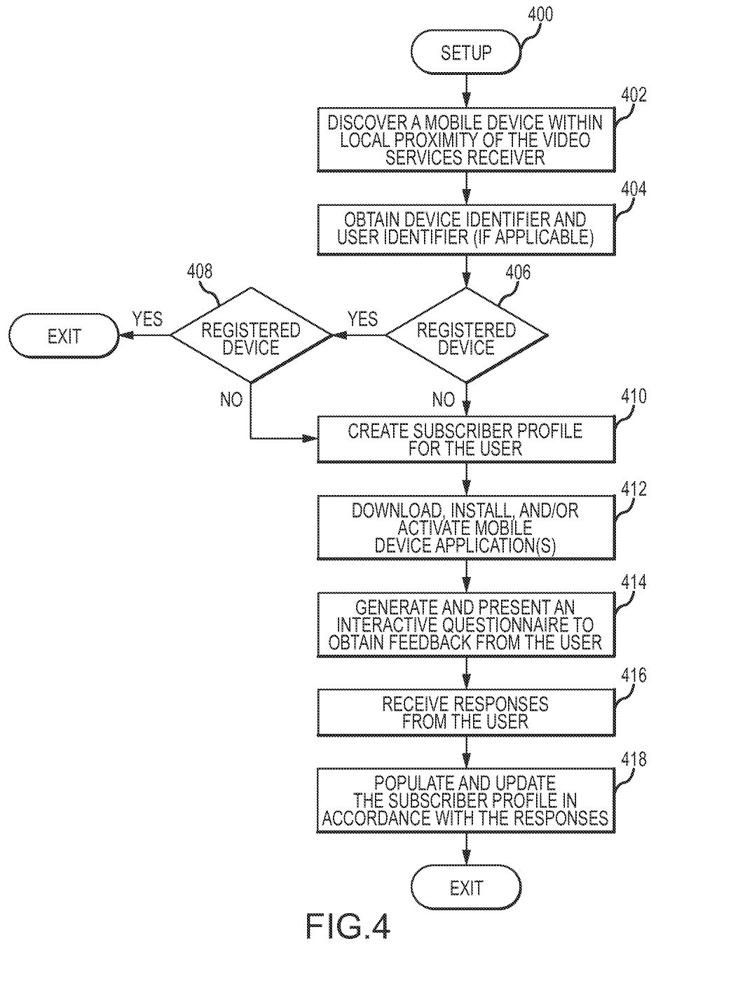

A subscriber profile 308 may be created or updated at any time to contemplate the addition of new users, new mobile devices, or the like. In some embodiments, a video services receiver can be used to discover and register a new mobile device and/or a new user of a previously registered mobile device. In this regard, FIG. 4 is a flow chart that illustrates an embodiment of a setup process 400 that may be performed with a video services system such as the system 100 shown in FIG. 1. The various tasks performed in connection with an illustrated process (such as the setup process 400) may be performed by software, hardware, firmware, or any combination thereof. The description of an illustrated process may refer to elements mentioned above in connection with FIGS. 1-3. In practice, portions of a described process may be performed by different elements of the described system, e.g., a mobile device, a video services receiver, a network-based server, or an operating module thereof. It should be appreciated that a described process may include any number of additional or alternative tasks, the tasks shown in the figures need not be performed in the illustrated order, and a described process may be incorporated into a more comprehensive procedure or process having additional functionality not described in detail herein. Moreover, one or more of the tasks shown in the figures could be omitted from an embodiment of a described process as long as the intended overall functionality remains intact.

The setup process 400 may begin when the system discovers or detects a mobile device that is within local proximity of a video services receiver (task 402). Task 402 may be performed by a video services receiver and/or by a network-based server or other component of the video services system. In certain embodiments, task 402 is associated with a wireless discovery operation or a wireless pairing routine where a short-range wireless link is established between the mobile device and the video services receiver. For example, task 402 may be associated with the creation of a Wi-Fi wireless data communication link, a BLUETOOTH wireless data communication link, a Digital Living Network Alliance (DLNA) wireless communication link, or the like. In some embodiments, the discovery performed during task 402 may be accomplished using global positioning system (GPS) technology, wireless locating techniques (such as triangulation), and may be accomplished using the video delivery network, a telecommunications network, a cellular communications network, the Internet, or the like. The setup process 400 assumes a user of a discovered mobile device will be located close to the presentation device(s) to which the video services receiver is connected.

This description assumes that a video services receiver discovers a mobile device and obtains a device identifier of the mobile device (task 404). In some situations, task 404 will also obtain a user identifier that identifies the current user of the mobile device (a user identifier may be provided if the mobile device supports multiple users). The identifiers may be obtained in connection with the discovery process (task 402) or they may be obtained after completion of the discovery process. In practice, the identifiers can be wirelessly communicated from the mobile device to the video services receiver (or, in some embodiments, to a network-based server).

The setup process 400 checks the device identifier to determine whether or not the mobile device is already registered with the system (query task 406). If the mobile device is already registered (the “Yes” branch of query task 406), then the setup process 400 checks the user identifier (if applicable) to determine whether or not the current user of the mobile device is already registered with the system (query task 408). If the current user is already registered, then the setup process 400 may exit. If query task 406 determines that the mobile device is unregistered, or if query task 408 determines that the current user is unregistered, then the setup process 400 continues by creating a subscriber profile for the current user (task 410). At this time, the subscriber profile may include a limited amount of information, such as the device identifier, the user identifier, a date stamp, an identifier of the registering video services receiver, location information related to the registering video services receiver, and the like. Upon creation, the subscriber profile may include little to no user-specific targeted advertising data because the current user is unknown to the system at this time.

The setup process 400 may initiate, prompt, or request the downloading, installation, and/or activation of one or more relevant mobile applications (task 412). In this regard, it may be desirable or necessary to have a suitably written mobile application installed on the mobile device for purposes of compatibility with the targeted advertising techniques described herein. Thus, the setup process 400 could initiate the downloading of a mobile application (from the video services receiver, from a cellular network, via an Internet connection, or the like) for installation on the mobile device. Alternatively, the setup process 400 could activate a mobile application that has been pre-installed on the mobile device. As yet another option, the setup process 400 could provide instructions to the user of the mobile device, such that the user can install or activate the mobile application(s) as needed.

The setup process 400 may continue and attempt to obtain user-specific information that might be helpful in connection with targeted advertising methodologies. For example, the setup process 400 may generate an interactive questionnaire that is configured for presentation to the current user of the mobile device (task 414). The interactive questionnaire may include questions intended to solicit feedback from the user, where the feedback can be used to determine how best to direct targeted advertising to that user. The questionnaire could be provided to the mobile device (using, for example, the mobile application) for presentation, and/or to the display device connected to the video services receiver. The interactive questionnaire may be designed to obtain responses and answers from the user via a graphical user interface of the mobile device, via a remote control device that controls the video services receiver, or the like. Regardless of the manner in which the user interacts with the questionnaire, the setup process 400 receives one or more responses from the user (task 416) and processes the responses in an appropriate manner.

The interactive questionnaire is designed to obtain user feedback that relates to the user's likes, dislikes, interests, demographic data, and the like. For example, the questionnaire may attempt to collect some or all of the user-specific targeted advertising data described above with reference to the content of the subscriber profiles 308. Moreover, the questionnaire may attempt to determine whether or not the current user likes specific advertisements or commercials, whether or not the current user likes certain types of advertising content (e.g., humorous, animated, somber, provocative, or the like), and/or whether or not the current user prefers to receive advertising content at certain times of the day.

This example assumes that the setup process 400 obtains at least some responses from the user (task 416). The collected user information can then be used to populate and update the subscriber profile that was created during task 410. The setup process 400 populates and updates the current user's subscriber profile in accordance with at least some of the responses (task 418). The setup process 400 may exit after the subscriber profile has been updated. Thereafter, the user's subscriber profile can be accessed and considered for purposes of targeted advertising that involves the user.

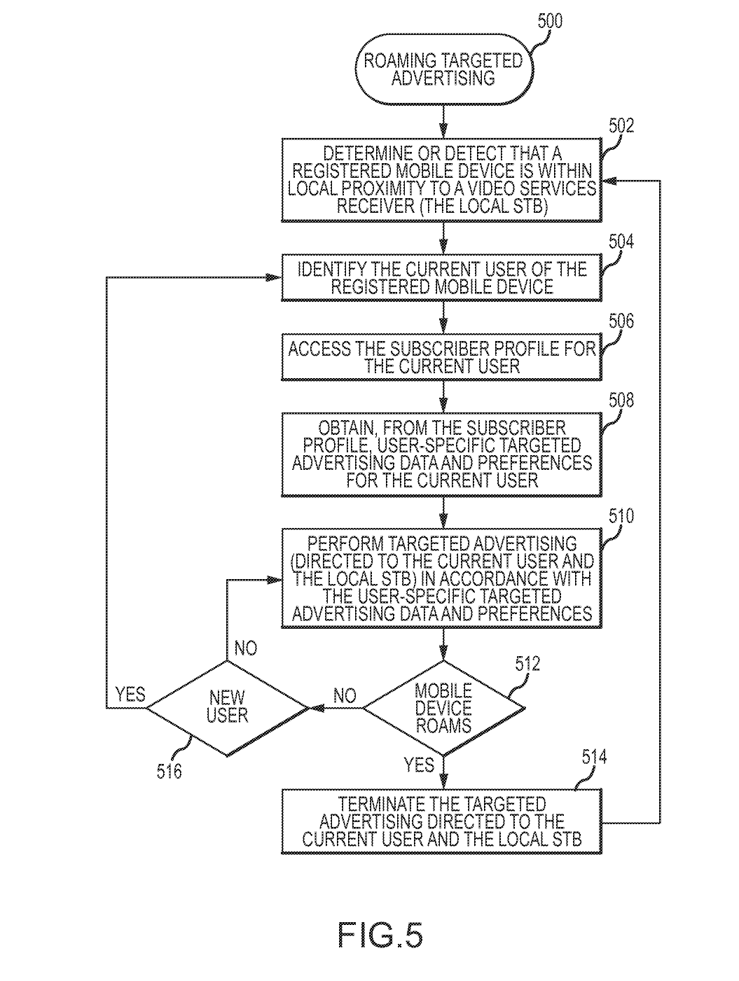

FIG. 5 is a flow chart that illustrates an embodiment of a roaming targeted advertising process 500 that may be performed with a video services system, such as the system 100 depicted in FIG. 1. The process 500 assumes that the mobile device and one or more users of the mobile device are already registered with the system. The process 500 determines or detects that a mobile device is within local proximity to a video services receiver (task 502). This determination uses a wireless communication capability of the mobile device. In some embodiments, the process 500 detects when wireless connectivity is established between the mobile device and the video services receiver. As mentioned above with reference to task 402 of the setup process 400, the video services receiver can perform wireless discovery to detect the presence of the mobile device, wherein the wireless discovery relies on the wireless range of a short-range wireless communication protocol that is natively supported by the mobile device. Thus, the determination of task 502 can be made after establishing a short-range wireless link between the mobile device and the video services receiver. The mobile device and the video services receiver may utilize one or more suitable short-range wireless technologies including, without limitation: Wi-Fi technology; BLUETOOTH wireless technology; infrared communication technology; wireless DLNA technology; wireless USB technology; a non-standard or proprietary wireless protocol; or the like.

The determination made during task 502 could also involve the use of position data, such as GPS data, that indicates a current geographic location of the mobile device. For example, the video services receiver could receive GPS data from the mobile device and forward the GPS data to a network-based server for processing in an appropriate manner. As another example, the mobile device could communicate GPS data to a network-based server using one or more networks that do not involve the video services receiver (such as the Internet or a cellular communications network). The position data of the mobile device may be analyzed to determine whether or not the current geographic location of the mobile device is less than a threshold distance away from a known geographic location of the video services receiver. In this regard, it may be possible for the process 500 to determine whether or not the mobile device is in close proximity to the video services receiver, based on position data (GPS information) provided by the mobile device.

This example assumes that the discovered mobile device and the current user are already registered with the system (if the mobile device or the user is not registered, then the setup process 400, or the relevant portions thereof, can be performed). The process 500 may continue by identifying the current user of the mobile device (task 504). Task 504 need not be performed if one and only one user is registered with the mobile device. If, however, the mobile device supports a plurality of different users, then task 504 can identify the current user from the plurality of different candidate users. As described above with reference to task 404 of the setup process 400, a user identifier may be provided by the mobile device such that the process 500 can identify the current user. In some embodiments, the user identifier is communicated from the video services receiver to a network-based server in a notification, a message, or any form of signaling data, such that the server can identify the current user of the mobile device.

In addition, the process 500 accesses the subscriber profile for the current user, wherein the accessed subscriber profile is linked to the user identifier in some manner. In certain embodiments, the subscriber profile is accessed by a network-based server, which may also be responsible for acquiring advertising content that is suitable for the current user. The subscriber profile includes or is otherwise associated with user-specific targeted advertising data and preferences for the current user. Accordingly, the process 500 obtains or processes the user-specific targeted advertising data for the current user (task 508) and performs targeted advertising in accordance with the user-specific targeted advertising data (task 510). Notably, the targeted advertising is directed to the current user and to the local video services receiver, with the assumption that the user is within close proximity of the local video services receiver. The targeted advertising is influenced by the user-specific targeted advertising data that is stored in association with the subscriber profile for the current user. Consequently, the process 500 can direct advertisements to the user in an intelligent and customized manner that is intended to keep the user interested.

The process 500 is capable of providing targeted advertising content to the current user of the mobile device in a roaming manner. In this regard, the targeted advertising scheme will roam with the user if the mobile device leaves the vicinity of the local video services receiver and enters the vicinity of another video services receiver that also supports the roaming targeted advertising process 500. Thus, if the mobile device roams away from the local video services receiver (the “Yes” branch of query task 512), then the process 500 terminates the targeted advertising action(s) that are directed to the current user and the local video services receiver (task 514). After the targeted advertising is terminated, the process 500 may exit or it may return to task 502 if another mobile device is discovered in close proximity to the local video services receiver.

If the mobile device remains within wireless range of the local video services receiver (the “No” branch of query task 512), then the process 500 may continue by checking whether or not a new user has logged into the mobile device (query task 516). For example, the mobile device may be a laptop computer that supports a plurality of different users, each having a different username or user profile associated with the laptop computer. If query task 516 detects a new user, then the process 500 may return to task 504 to identify the new user. If query task 516 does not detect a new user, then the process 500 may return to task 510 to continue providing the targeted advertising to the same user.

The process 500, the mobile device, the video services receivers, and/or the video services system may be suitably configured to handle situations where the mobile device is within wireless range of two or more video services receivers at the same time. Under these conditions, the current user may be viewing video content provided by a first video services receiver, and another user may be viewing different video content provided by a second video services receiver. Consequently, it may not be productive to direct the targeted advertising intended for the current user to the second video services receiver. This scenario can be addressed by implementing certain techniques and procedures that are designed to select at least one “primary” video services receiver for purposes of targeted advertising. For example, the system could leverage GPS technology, received signal strength indication (RSSI) technology, wireless triangulation techniques, and/or other location-determining techniques to determine which video services receiver (among a plurality of receivers that are within wireless range of the mobile device) is the closest to the mobile device. The closest video services receiver can then be designated as the one to be used to deliver targeted advertising to the user of the mobile device. Selection of one designated video services receiver in this manner increases the likelihood that targeted advertising will actually reach the intended person.

Moreover, the process 500, the mobile device, the video services receivers, and/or the video services system may be suitably configured to cooperate with wireless access devices (e.g., wireless network routers or Wi-Fi access points). For example, if a compatible mobile device is within range of an access device, then the mobile device could communicate its status to the network-based server. The status notification may include an identifier of the wireless access device such that the network based-server can determine the approximate geographic location of the mobile device based on a known location of the access device. As another example, the access device could be designed to generate a status report to the network-based server in response to the detection of the mobile device. Thus, the access device may generate a status report when the mobile device registers with that particular access device, such that the network-based server can estimate the location of the mobile device based on a known location of the access device.

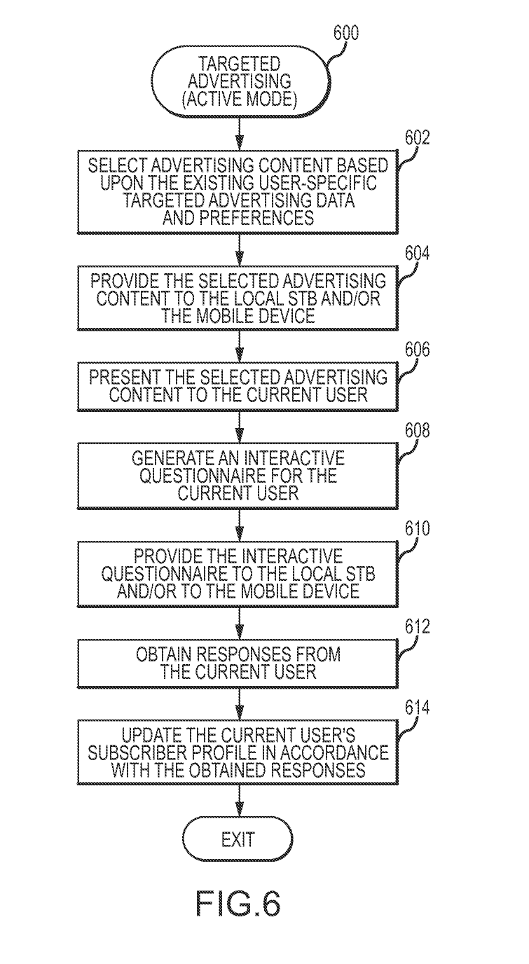

The targeted advertising action provided by the system is influenced or determined by the user-specific targeted advertising data that is maintained in the subscriber profile for the current user. A variety of targeted advertising schemes, methodologies, and approaches could be utilized in the context of the video services system described here. For example, FIG. 6 is a flow chart that illustrates an embodiment of a targeted advertising process 600 that utilizes an active scheme. It should be appreciated that the process 600 (or portions thereof) may be performed during task 510 of the process 500. The targeted advertising activity associated with process 600 may include selecting appropriate advertising content that is based upon, or is otherwise influenced by, the user-specific targeted advertising data and user preferences (task 602). The advertising content is selected based on the current status of the subscriber profile for the current user. In practice, the process 600 can utilize any targeted advertising methodology, algorithm, or technique to select relevant advertising content that is customized or directed to the current user. For example, task 602 could select advertising content that matches one or more topics or subjects of interest identified in the subscriber profile (e.g., cooking, automobiles, skateboarding, computers, or sports). As another example, task 602 could select advertising content based on tags, labels, and/or other metadata in the subscriber profile that classifies or categorizes the user-preferred advertising content. Moreover, task 602 could utilize a “like minded” approach that selects the advertising content based on preferences, likes, and/or dislikes of other users that share at least some common traits or characteristics with the current user. For example, if it is known that the current user is a 35 year old female who enjoys sports, progressive rock music, and fine wine, then task 602 might select advertising content that has been viewed and “liked” by other people who are less than 40 years old, enjoy sports, and enjoy rock music.

The selected advertising content is then provided to the local video services receiver and/or to the mobile device via an appropriate delivery mechanism (task 604). For example, the video services network may be used to deliver the selected advertising content from one or more network-based servers to the video services receiver. Alternatively (or additionally), a cellular communications network and/or the Internet could be employed to deliver the selected advertising content to the mobile device and/or to a different electronic or computing device without involving the video services receiver. As yet another example, the advertising content could be delivered from the video services receiver to the mobile device using the short-range wireless link. If the selected advertising content is provided to the video services receiver, then the process 600 continues by presenting the selected advertising content, using the presentation device or equipment that is coupled to the video services receiver. If the selected advertising content is provided to the user's mobile device, then the process 600 continues by presenting the selected advertising content, using the media content capabilities of the mobile device. In any event, the selected advertising content is presented to the current user of the mobile device (task 606).

The process 600 represents an active targeted advertising scheme in that it generates an interactive questionnaire that includes at least one question for the current user (task 608) and provides the questionnaire to the local video services receiver and/or to the mobile device (task 610) for consideration by the user. In certain embodiments, the questionnaire is generated by a network-based server of the video services system. In other embodiments, the questionnaire could be generated at the video services receiver or at the mobile device (e.g., by a suitably configured mobile application running on the user's mobile device). The questionnaire includes one or more questions designed to solicit advertising feedback from the current user, as described above with reference to task 414 of the setup process 400. For example, the questionnaire may ask the user whether or not the last-played advertisement was relevant to his or her interests, whether or not the user actually viewed or listened to a recent advertisement, whether the user is more or less inclined to purchase an advertised product, whether the user liked or disliked an advertisement, etc. Moreover, the questionnaire could solicit any of the information described above for task 414 and/or solicit any information suitable for use in the subscriber profile of the current user.

The interactive questionnaire can be provided to the user in any suitable format and in any appropriate manner. For example, the interactive questionnaire could be provided using any of the methodologies described above for the delivery of the selected advertising content. This allows the user to respond to the questions and provide responses if so desired. This example assumes that the process 600 obtains at least some responses to the questions (task 612). Task 612 may be associated with user interaction with one or more graphical user interfaces generated by the video services receiver, the mobile device, or another computing device operated by the user. For example, the user could enter and submit text responses, submit responses to one or more multiple choice questions, or the like. The responses may be sent to a network-based server of the video services system using the video services receiver and associated network, via a cellular network available to the mobile device, via the Internet, or the like. This example assumes that the process 600 obtains the user responses and updates the current user's subscriber profile in accordance with the obtained responses (task 614). More specifically, the process 600 updates the user-specific targeted advertising data as needed to reflect the user's answers to the questions contained in the interactive questionnaire. Dynamically updating the user's subscriber profile in this manner is desirable to enhance the selection of future advertising content for the user. Ideally, this type of updating will “fine tune” the targeted advertising actions in an ongoing manner to increase the likelihood that relevant advertising content is delivered to the user.

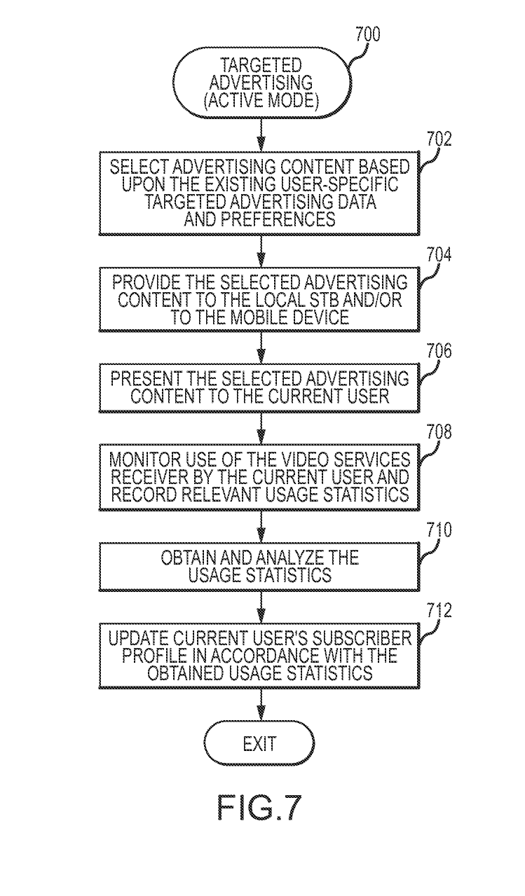

FIG. 7 is a flow chart that illustrates an embodiment of a targeted advertising process 700 that utilizes a stealth scheme. It should be appreciated that the process 700 (or portions thereof) may be performed during task 510 of the process 500. The process 700 may select advertising content (task 702), provide the selected advertising content to the local video services receiver and/or to the mobile device (task 704), and present the advertising content to the current user (task 706), as described above for the process 600.

The process 700 corresponds to a stealth mode because it performs certain targeted advertising actions without the knowledge of the current user. For example, the process 700 can monitor the use of the video services receiver by the current user of the mobile device, and record any relevant usage statistics (task 708). The usage statistics may be indicative of the viewing habits of the current user and, as such, may be helpful in determining whether the user actually viewed certain advertisements, whether the user enjoys certain types of programming, and the like. In practice, the usage statistics may include or indicate some or all of the following information, without limitation: favorite channels of the user; program events viewed or recorded by the user; advertisements viewed or recorded by the user; typical viewing days and time slots for the user; recordings scheduled by the user; DVR content stored, downloaded, or played back by the video services receiver; and the like.

In some embodiments, the local video services receiver sends the usage statistics to at least one network-based server of the video services system. This description assumes that the usage statistics are obtained and analyzed in an appropriate manner (task 710). The usage statistics can be analyzed and processed to update the current user's subscriber profile (task 712). More specifically, the process 700 updates the user-specific targeted advertising data (if needed) to reflect the user's viewing or recording habits, usage patterns, and the like. In other words, the user-specific targeted advertising data is updated in a manner that is influenced at least in part by the obtained usage statistics. Dynamically updating the user's subscriber profile in this manner is desirable to enhance the selection of future advertising content for the user. Ideally, this type of updating will “fine tune” the targeted advertising actions in an ongoing manner (and without the user's knowledge) to increase the likelihood that relevant advertising content is delivered to the user.

To summarize, the techniques and methodologies presented here enable a video services system to create and maintain subscriber profiles for end users, where the profiles can be associated with mobile devices owned or operated by the end users. Using a form of local networking (e.g., Wi-Fi, BLUETOOTH wireless technology, or the like), a video services receiver, a television set, or other piece of customer premises equipment can detect when a compatible mobile device is near. Thereafter, the system can operate in a stealth mode or in an active mode. In the active mode, the system presents the user with an interactive display or questionnaire to collect information related to what advertisements the user prefers, which companies the user likes, etc. In the stealth mode, the video services receiver monitors and tracks certain user viewing behaviors (e.g., which advertisement a user watches or records) and updates the subscriber profile in response to the monitored usage statistics and data. The subscriber profiles are used to determine targeted advertising content suitable for each end user. The methodology described here can also support multiple users in a single household, multiple video services receivers in a localized area, and a mobile device that accommodates multiple user logins.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A targeted advertising method for a video services system, the method comprising:
determining that a mobile device is within local proximity to a video services receiver, wherein the determining uses a wireless communication capability of the mobile device;
in response to the determining, identifying a current user of the mobile device;
accessing a subscriber profile for the current user, the subscriber profile comprising user-specific targeted advertising data for the current user; and
performing targeted advertising directed to the current user, wherein the performing is influenced by the user-specific targeted advertising data.

2. The targeted advertising method of claim 1, wherein the determining comprises detecting wireless connectivity between the mobile device and the video services receiver.

3. The targeted advertising method of claim 1, wherein the determining comprises:
receiving position data that indicates a current geographic location of the mobile device; and
determining that the current geographic location of the mobile device is less than a threshold distance away from a known geographic location of the video services receiver.

4. The targeted advertising method of claim 1, wherein:
the mobile device supports a plurality of different users; and
the identifying identifies one of the plurality of different users as the current user of the mobile device.

5. The targeted advertising method of claim 1, wherein the determining uses a short-range wireless communication protocol that is natively supported by the mobile device.

6. The targeted advertising method of claim 1, wherein the user-specific targeted advertising data comprises data selected from the group consisting of: age of the current user; gender of the current user; nationality of the current user; ethnicity of the current user; occupation of the current user; education level of the current user; usage statistics associated with use of the video services receiver by the current user; media content preferences of the current user; advertising preferences of the current user; demographic data associated with the current user; address data associated with the current user; telephone number data associated with the current user; personality traits of the current user; familial information associated with the current user; and subject matter preferences of the current user.

7. The targeted advertising method of claim 1, wherein performing targeted advertising directed to the current user comprises:
selecting advertising content based upon the user-specific targeted advertising data, resulting in selected advertising content; and
providing the selected advertising content to the video services receiver for presentation to the current user.

8. The targeted advertising method of claim 1, wherein performing targeted advertising directed to the current user comprises:
selecting advertising content based upon the user-specific targeted advertising data, resulting in selected advertising content; and
providing the selected advertising content to the mobile device for presentation to the current user.

9. The targeted advertising method of claim 1, further comprising:
generating an interactive questionnaire for the current user, wherein the interactive questionnaire includes one or more questions to solicit advertising feedback from the current user; and
providing the interactive questionnaire to the video services receiver for presentation to the current user.

10. The targeted advertising method of claim 9, further comprising:
obtaining responses to the one or more questions; and
updating the user-specific targeted advertising data in response to the obtained responses.

11. The targeted advertising method of claim 1, further comprising:
generating an interactive questionnaire for the current user, wherein the interactive questionnaire includes one or more questions to solicit advertising feedback from the current user; and
providing the interactive questionnaire to the mobile device for presentation to the current user.

12. The targeted advertising method of claim 11, further comprising:
obtaining responses to the one or more questions; and
updating the user-specific targeted advertising data in response to the obtained responses.

13. The targeted advertising method of claim 1, further comprising:
obtaining usage statistics associated with use of the video services receiver by the current user; and
updating the user-specific targeted advertising data in response to the obtained usage statistics.

14. A video services system comprising:
a network interface to communicate data between the video services system and a plurality of video services receivers;
a memory element to store a plurality of subscriber profiles, each of the plurality of subscriber profiles comprising user-specific targeted advertising data for a different subscriber supported by the video services system; and
a processor coupled to the network interface and to the memory element, wherein the processor determines that a mobile device is within local proximity to one of the plurality of video services receivers, identifies a current user of the mobile device, accesses a designated subscriber profile for the current user from the plurality of subscriber profiles, and performs targeted advertising directed to the current user of the mobile device in accordance with the user-specific targeted advertising data in the designated subscriber profile.

15. The video services system of claim 14, wherein the processor determines that the mobile device is within local proximity to one of the plurality of video services receivers in response to detection of wireless connectivity between the mobile device and the one of the plurality of video services receivers.

16. The video services system of claim 15, wherein:
the processor receives a notification from the one of the plurality of video services receivers; and
the notification identifies the current user of the mobile device.

17. The video services system of claim 14, wherein the user-specific targeted advertising data in the designated subscriber profile comprises data selected from the group consisting of: age of the current user; gender of the current user; nationality of the current user; ethnicity of the current user; occupation of the current user; education level of the current user; usage statistics associated with use of the video services receiver by the current user; media content preferences of the current user; advertising preferences of the current user; demographic data associated with the current user; address data associated with the current user; telephone number data associated with the current user; personality traits of the current user; familial information associated with the current user; and subject matter preferences of the current user.

18. The video services system of claim 14, wherein:
the processor generates an interactive questionnaire for the current user;
the interactive questionnaire includes one or more questions to solicit advertising feedback from the current user; and
the video services system uses the network interface to provide the interactive questionnaire to the one of the plurality of video services receivers for presentation to the current user.

19. The video services system of claim 18, wherein:
the video services system uses the network interface to obtain responses to the one or more questions; and
the processor updates the user-specific targeted advertising data in the designated subscriber profile in accordance with the obtained responses.

20. The video services system of claim 14, wherein:
the video services system uses the network interface to obtain usage statistics associated with use of the one of the plurality of video services receivers by the current user; and
the processor updates the user-specific targeted advertising data in the designated subscriber profile in accordance with the obtained usage statistics.

21. A targeted advertising method for a video services system, the method comprising:
establishing a short-range wireless link between a mobile device and a video services receiver;
receiving, from the mobile device and via the short-range wireless link, a user identifier that identifies a current user of the mobile device;
communicating the user identifier from the video services receiver to a network-based server of the video services system; and
thereafter, performing a targeted advertising action at the video services receiver, wherein the targeted advertising action is influenced by user-specific targeted advertising data maintained by the network-based server in association with the user identifier.

22. The targeted advertising method of claim 21, wherein:
the mobile device supports a plurality of different users; and
the user identifier identifies one of the plurality of different users as the current user of the mobile device.

23. The targeted advertising method of claim 21, wherein the user-specific targeted advertising data comprises data selected from the group consisting of: age of the current user; gender of the current user; nationality of the current user; ethnicity of the current user; occupation of the current user; education level of the current user; usage statistics associated with use of the video services receiver by the current user; media content preferences of the current user; advertising preferences of the current user; demographic data associated with the current user; address data associated with the current user; telephone number data associated with the current user; personality traits of the current user; familial information associated with the current user; and subject matter preferences of the current user.

24. The targeted advertising method of claim 21, wherein:
the network-based server selects advertising content based upon the user-specific targeted advertising data, resulting in selected advertising content; and
the targeted advertising action comprises receiving the selected advertising at the video services receiver for presentation to the current user.

25. The targeted advertising method of claim 21, wherein:
the network-based server generates an interactive questionnaire for the current user, wherein the interactive questionnaire includes one or more questions to solicit advertising feedback from the current user; and
the targeted advertising action comprises receiving the interactive questionnaire at the video services receiver for presentation to the current user.

26. The targeted advertising method of claim 25, further comprising:
obtaining responses to the one or more questions; and
sending the obtained responses to the network-based server for updating the user-specific targeted advertising data.

27. The targeted advertising method of claim 21, further comprising:
obtaining usage statistics associated with use of the video services receiver by the current user; and
sending the obtained usage statistics to the network-based server for updating the user-specific targeted advertising data.
